(19) United States
(12) Patent Application Publication
(10) Pub. No.: US 2009/0113435 A1
(43) Pub. Date: Apr. 30, 2009

(54) INTEGRATED BACKUP WITH CALENDAR

(76) Inventors: Boaz Mizrachi, Haifa (IL); Aviad Zlotnick, Mitzpeh Netofah (IL)

Correspondence Address: DUKE W. YEE, YEE & ASSOCIATES, P.C, P.O BOX 802333, DALLAS, TX, 75380, US

(21) Appl. No.: 11/926,814

(22) Filed: Oct. 29, 2007

(51) Int. Cl. G06F 9/46

(52) U.S. Cl. 718/102

(57) ABSTRACT

A computer implemented method, apparatus, and computer program product for automatically scheduling execution of a process using information in a calendar. Entries in a set of electronic calendars associated with a set of users are analyzed to generate expected computer usage patterns for the set of users. A low usage time interval for a computer is identified using the expected computer usage patterns. The low usage time interval for the computer is a time interval when expected usage of the computer by the set of users does not exceed a threshold amount of usage. The process is automatically executed during the low usage time interval.

### BACKGROUND OF THE INVENTION

1. Field of the Invention

The present invention is related generally to a data processing system and in particular to a method and apparatus for scheduling processes. More particularly, the present invention is directed to a computer implemented method, apparatus, and computer usable program code for utilizing information from a user's calendar to schedule execution of maintenance processes.

2. Description of the Related Art

A maintenance process is a process that performs a maintenance task associated with a computing device. A maintenance process includes, without limitation, a backup process for backing up data, a defragmentation process for de-fragmenting a disk, a virus scan, a de-duplication process, or any other maintenance process. Backing up data refers to making copies of the data which are referred to as backups. A backup is a secondary copy of original data. Backups may be used to restore data on a computer after the original data has been lost, deleted, or corrupted. The process of restoring data on a computer using backups is sometimes referred to as data recovery or disaster recovery.

Backup software is software that makes a copy of original data to create the backup copy of the data. Because the backup process can consume considerable processor resources and time, depending on the amount of data being backed up, the backup process can cause a significant degradation in a computer's responsiveness. Consequently, if a backup is performed at a time when a user is utilizing the resources of the computer, the user's work efficiency may be negatively impacted.

Automatic backups and other maintenance processes can be scheduled to occur at a regular day and time. For example, a user can program a backup to occur automatically at midnight when the user does not anticipate using the computer. However, such scheduling does not take into account the need for scheduling incremental backups at more frequent or regular intervals. In addition, the manually set backup time is static and does not take into account a user's changing schedule and changing needs to utilize the resources of the computing system.

Current systems often run maintenance processes while the computer is idle. However, automatic detection of idle mode is sensitive. Therefore, any background operation, such as Google® Desktop updating an index, an antivirus scan, or downloading a patch to the system or computer, frequently takes the computer out of idle mode. In some cases, these background operations can eat up all the idle time and prevent a process, such as a backup, from happening. In addition, these existing systems can be very unpredictable. Current systems generally cannot accurately predict time intervals during which a user will not require the full power of the computer without the user manually setting a date and time to execute the maintenance process. However, manually changing the scheduled time for the maintenance process can be both cumbersome and inefficient for a user.

### SUMMARY OF THE INVENTION

The illustrative embodiments provide a computer implemented method, apparatus, and computer program product for automatically scheduling execution of a process using information in a calendar. Entries in a set of electronic calendars associated with a set of users are analyzed to generate expected computer usage patterns for the set of users. A low usage time interval for a computer is identified using the expected computer usage patterns. The low usage time interval for the computer is a time interval when expected usage of the computer by the set of users does not exceed a threshold amount of usage. The process is automatically executed during the low usage time interval.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram illustrating a data flow through a computing device when information from a calendar is used to automatically schedule execution of a backup process in accordance with an illustrative embodiment;

FIG. 4 is a block diagram of a calendar entry screen having a low usage indicator in accordance with an illustrative embodiment;

FIG. 5 is a flowchart illustrating a process for identifying low usage time intervals using information from a calendar in accordance with an illustrative embodiment; and

FIG. 6 is a flowchart illustrating a process for using information from a calendar to perform a global backup in accordance with an illustrative embodiment.

### DETAILED DESCRIPTION OF THE PREFERRED EMBODIMENT

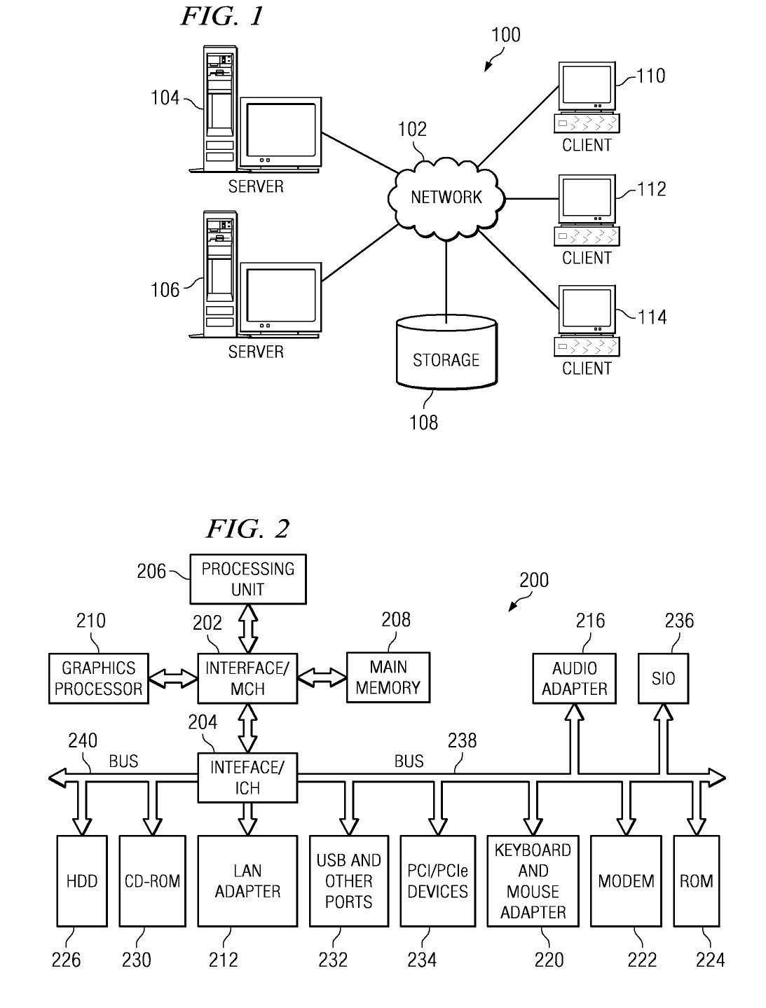

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft Windows Vista (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

A backup process can consume considerable processor resources and time. Depending on the amount of data being backed up, the backup process can cause a significant degradation in a computer's responsiveness. Consequently, if the backup process is performed at a time when a user is utilizing the resources of the computer, the user's work efficiency may be negatively impacted.

Currently, automatic backups can be scheduled to occur at a regular day and time. For example, a user can program a backup to occur automatically at midnight when the user generally does not utilize the computer. However, such scheduling does not take into account the need for scheduling incremental backups at more frequent or regular intervals. Furthermore, it is frequently the case that a computer is not connected to the network at some times of the day, for example, and without limitation, a laptop computer may be disconnected when its user is at home. In addition, a system may require frequent backups throughout a workday to ensure accurate backups of changing data are maintained at all times. In addition, the backup time set using this solution is static and does not take into account a user's changing needs and requirements for utilization of system resources. For example, a user may need to use the computer system's resources at an unusual or irregular time of the day or night, when the backup is scheduled to occur. If the backup occurs at that time, the user's work efficiency could be severely limited by the occurrence of the backup.

Current backup systems typically cannot accurately predict time intervals during which a user will not require the full power of the computer without the user manually setting a backup date and time. However, manually changing the scheduled time for the automatic backup can be both cumbersome and inefficient for a user.

The illustrative embodiments recognize a need for a data processing system that is capable of automatically and dynamically performing a backup of data on a computer, and/or performing any other maintenance processes, during a time interval when one or more users do not need to utilize resources of the computer or during a time interval when the user only needs the computer resources for tasks that are not processor intensive tasks, such that performing the task while the backup process is occurring will not significantly impact completion of the task. It is difficult or impossible for the backup system to predict time intervals when users will not need to use the computer's resources and/or time intervals when process intensive tasks will not be performed.

The illustrative embodiments recognize that users are frequently aware of time intervals when users will require the computer's resources and time intervals when the users will not need to use the computer's resources. This information regarding time intervals when a user will not be using the computer is frequently included in the user's calendar, email account, personal digital assistant (PDA), or other organization or planning software. Thus, the illustrative embodiments recognize a need to combine a backup process with the user's knowledge of expected computer usage patterns.

Therefore, the illustrative embodiments provide a computer implemented method, apparatus, and computer program product for automatically scheduling a time to perform a process using information from a user's calendar. In one embodiment, entries in a set of electronic calendars are analyzed. As used herein, the term set refers to one or more. Thus, a set of electronic calendars could include a single electronic calendar, as well as two or more calendars.

The electronic calendars are associated with a set of users. The set of users is a set of one or more users. The electronic calendars are used to generate expected computer usage patterns for the set of users. Low usage time intervals for a computer are identified using the expected computer usage patterns. A low usage time interval for the computer is a time interval when expected usage of the computer by the set of users does not exceed a threshold amount of usage. The process is automatically executed during the low usage time interval.

The process may be a maintenance process. A maintenance process is a process for performing maintenance on the computer. A maintenance process includes, but is not limited to, a backup process for backing up data, a virus scan, a disk de-fragmentation process, a file compression process, a software update process, an anti-spyware process, a checkpoint process, a restart or restoration process for restoring applications and processes using checkpoint data, a software migration process, a software update, a diagnostic process, a trap handler, a text index manipulation process, or any other type of process that requires the resources of a computer.

In a situation in which multiple users are involved, there are two aspects of multi-user scheduling that are considered. The first, as described above, is suitable to the case when several users utilize or have access to the same computer. A second aspect of multi-user scheduling involves multiple users, with multiple computers, sharing a common resource for their maintenance process. A common resource includes, without limitation, a network server, a backup server, or a data storage device. In the latter case an optimal schedule is not one in which the maintenance process is run for all users at the same time. Rather, the optimal time to run the maintenance process is determined on the level of each individual computer. For example, if two computers share a single resource, an optimal time to run a maintenance process on the first computer may be at an early morning time while an optimal time to run the same process on the second computer is a time later in the afternoon.

Thus, in one embodiment, low usage time intervals are identified for each computer in a set of two or more computers. An optimal low usage time interval for all the computers in the set of computers is then identified using the low usage time intervals. The optimal low usage time interval is a time interval that encompasses or spans an interval that includes a low usage time interval for each computer in the set of computers. For example, if a first computer has low usage time intervals of 12:55-1:25 and 4:42-530 and a second computer has low usage time intervals of 12:20-1:10 and 3:00-3:15, an optimal time interval would span the time from 12:55-1:10 when a low usage time is expected for both computers.

In another embodiment, a low usage time interval is identified for each computer in a set of computers using the expected computer usage patterns to form low usage time intervals. The set of computers is a set of two or more computers. In this example, a set of common low usage time intervals is identified. The set of common low usage time intervals may include a single common low usage time interval, as well as two or more common low usage time intervals. Each low usage time interval in the set of common low usage time intervals is a low usage time interval for a threshold number of computers in the set of computers.

In this example, a lowest usage time interval in the set of common low usage time intervals is identified. The lowest usage time interval is a time interval when expected usage of the computers in the set of computers by the set of users is a lowest amount of expected usage. The process automatically executes in each computer in the set of computers during the lowest usage time interval.

However, in another embodiment, a low usage time interval is identified for each individual computer in the set of computers. In this case, the low usage time interval for each individual computer is a different time interval. In this example, the maintenance process is executed at a different time in each computer in the set of computers.

In one embodiment, the process executes simultaneously in all the computers in the set of computers during the lowest usage time interval. In another example, the process may not execute in all of the computers in the set of computers simultaneously. In other words, the process may begin execution in a first computer in the set of computers, then begin execution in a second computer in the set of computers after a delay of any amount of time.

In another embodiment, analyzing the entries in the set of electronic calendars further comprises identifying an entry in the set of entries associated with a given user in the set of users. The set of entries is a set of one or more entries in at least one electronic calendar. In this example, a time interval associated with the entry as a low usage time interval is identified in response to identifying a low usage indicator flag associated with the entry.

In yet another embodiment, analyzing the entries in the set of electronic calendars includes identifying an entry in the set of entries associated with a given user in the set of users. In response to a calendar status associated with the calendar entry indicating a user is on vacation, a time interval associated with the calendar status is identified as a low usage time interval.

In another example, analyzing the entries in the set of electronic calendars includes identifying an entry in the set of entries associated with a given user in the set of users and performing a text analysis on text associated with the entry to form text analysis results. One example of text analysis is a coding system for high data volume where strings of text are mapped to classes. In this example, strings are being mapped to “Low” and “High” usage classes, or “Local” and “Remote” locations. Any other text analysis system may also be utilized without departing from the scope of the illustrative embodiments.

In response to the text analysis results indicating that an expected location of the given user is a different location than a location of the computer, a time interval associated with the entry is identified as a low usage time interval. In response to the text analysis results indicating that an activity described in the entry is a low usage activity, the time interval associated with the entry is identified as the low usage time interval.

The illustrative embodiments may also be performed as a service, either manually or automatically, over a network. In one embodiment, the entries in the set of electronic calendars are received by a server from a client via a network connection. The network connection may be an intranet, extranet, internet, a local area network (LAN), a wide area network (WAN), a wireless network, or any other type of known or available network.

The illustrative embodiments may be performed by a service to customers. In this example, a client, such as client 110 in FIG. 1, sends calendar entries to a server associated with the service provider by the server, such as server 104 in FIG. 1. The entries in the set of electronic calendars are analyzed to generate the expected computer usage patterns and identify the low usage time intervals using the expected computer usage patterns. The low usage time intervals for the computer are transmitted from the server back to the client. This service may be performed for a fee or other compensation. The service may also be performed by automation in which a process automatically performs the illustrative embodiments wholly without human intervention. The process may also be performed manually by human users analyzing the text. The process may also be implemented in part by human users and in part by computer hardware and software.

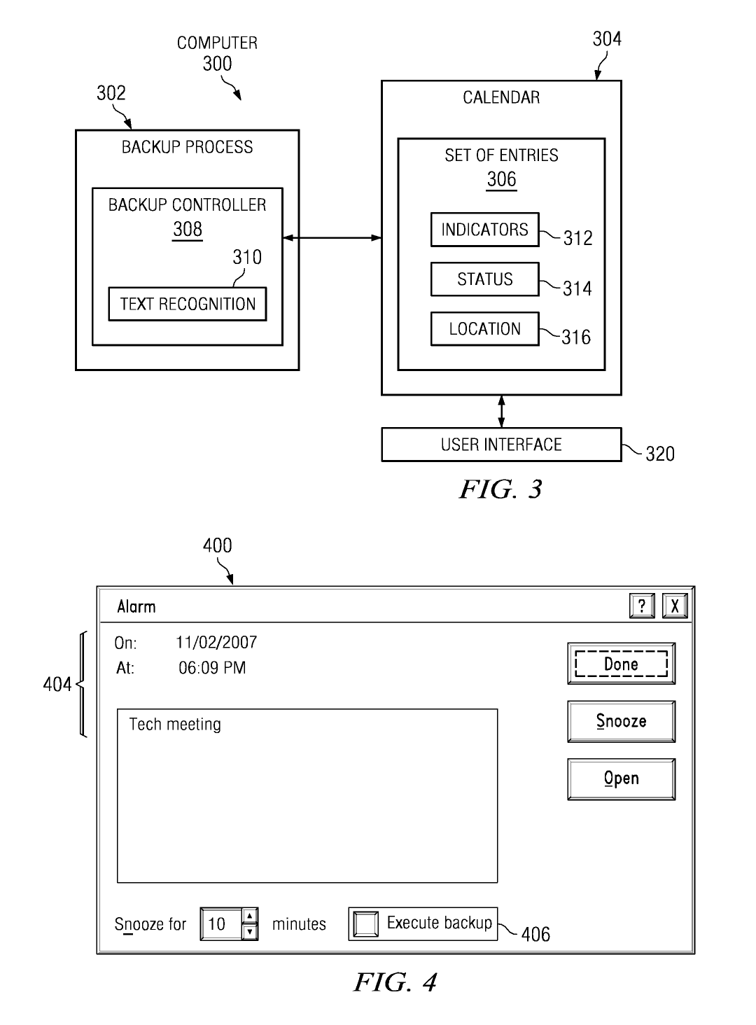

FIG. 3 is a block diagram illustrating a data flow through a computing device when information from a calendar is used to automatically schedule execution of a backup process in accordance with an illustrative embodiment. Computer 300 may be implemented using any type of computing device, such as a personal computer, laptop, personal digital assistant, a server, or any other computing device depicted in FIGS. 1 and 2.

Backup process 302 is a software process used to backup data on computer 300. Backup process 302 uses Backup controller 308 to manage, control, and/or schedule execution or initiation of backup process 302.

Text recognition 310 is a text analysis tool for analyzing and recognizing text from calendar 304. Text recognition 310 may be implemented in any known or available text recognition software, such as, without limitation, optical character recognition (OCR) software, intelligent character recognition (ICR), a parser for parsing natural human language into data that is usable by a program, and/or any other type of text recognition software for extracting data from entries written in natural human language. OCR and ICR are used for this task where the information in calendar 304 is in handwriting or an image of handwriting, such as a facsimile (fax). OCR is used to translate images to coded text. A parser or other text recognition software is used to parse human language text in an electronic entry into data usable by a computer.

Text recognition 310 parses human readable text, sentences, words, letters, numbers, symbols, and/or characters to identify a time of an activity, a day of the activity, a location of the activity, a type of the activity, participants in the activity, a name of the activity, a category of the activity, and/or any other information associated with activities described in calendar 304.

In this example, calendar 304 can be any form of electronic calendar located on computer 300. A calendar in the set of electronic calendars associated with a set of users includes, without limitation, a calendar in an email program, a calendar in a personal digital assistant, a calendar in a personal organizer, a calendar associated with a cell phone or Ipod, a calendar in a modular calendaring software program, a calendar associated with a task list or to-do list, a calendar provided as an internet service, or any other type of electronic calendar. In another embodiment, calendar 304 is an image of a calendar printed on a paper medium having handwritten or typed entries. In this example, OCR or ITR is used to convert the handwritten or typed text in the image of the calendar into data for utilization by computer 300.

Calendar 304 may be located on the hard drive of Computer 300, or located within a software program that allows a user to receive email and to input entries related to the user's schedule. Calendar 304 may be a daily calendar, monthly calendar, a yearly calendar, or any combination thereof.

In this example, calendar 304 is located on or locally to computer 300. In another embodiment, calendar 304 is located on a remote computing device, such as, but not limited to, a remote desktop computer, cellular telephone, personal digital assistant, or a remote server. In such a case, computer 300 receives calendar 304 and/or set of entries 306 from the remote computing device via a network connection. The calendar can also be located on removable storage, such as a USB stick.

Calendar 304 includes without limitation at least one or more of sets of entries 306. Set of entries 306 are entries located within a user's calendar that describe any type of activity or event. An example of an entry in set of entries 306 is discussed in more detail in FIG. 4 below.

In this example, set of entries 306 is composed of but not limited to, indicators 312, status 314, and location 316. Indicators 312, status 314, and location 316 may be set up either manually by the user or automatically by a software program or network provider.

Indicators 312 are composed of a series of variables used by text recognition 310 to make a determination whether an entry from among set of entries 306 is a low usage time interval. An indicator is a symbol, flag, variable, entry in a table, or other identifier that identifies a time interval in a plurality of time intervals as a low usage time interval.

A low usage time interval is a time interval when a user is scheduled to attend an activity or perform an activity that does not require any utilization of the computer resources, an activity that requires only minimal utilization of the computer resources, and/or the activity is scheduled to take place at a location remote to the computer.

An indicator in indicators 312 is set to indicate a low usage time interval manually by a user or automatically by a software process, such as text recognition 310. Text recognition 310 parses set of entries 306 to identify low usage time intervals based on the types of activities the user has scheduled, the location of the activities the user has scheduled, and/or the duration of the activities the user has scheduled. In response to identifying a time interval as a low usage time interval, text recognition 310 sets an indicator in indicators 312 to designate the time interval as a low usage time interval.

Status 314 is a status of a user and/or usage of the computer resources. For example, status 314 is set to indicate when a user is on vacation, sick leave, sabbatical, or maternity leave. Backup controller 308 checks status 314 to identify low usage time intervals. For example, if status 314 indicates the sole user of a computing device is on vacation all day on a given date, backup controller 308 identifies all time intervals for the given data as low usage time intervals based on status 314.

Location 316 is a field in calendar 304 that indicates a location of an activity. Location 316 indicates if a location of an activity is the same location as the location of the computer or whether the location of the activity associated with an entry among the set of entries 306 is remote to the computer. For example, if the user's computer is located in an office in Dallas, Tex. and the user has an event scheduled to take place in Austin, Tex., location 316 indicates that the location is remote to the computer. The time interval for the event is then designated as a low usage time interval because the user is scheduled to attend a remote event away from the computer.

User interface 320 is a software tool that allows the user to enter information into computer 300. User interface 320 is any type of known or available interface for providing input to computer 300, including but not limited to, a graphical user interface (GUI), a menu-driven interface, a speech/voice recognition system, and/or a command line interface.

User interface 320 allows a user to create entries in set of entries 306, manually set one or more indicators in indicators 312, manually set status 314, and manually enter a location into location 316 within an entry among set of entries 306.

Once the user inputs status 314, location 316, and/or one or more indicators in indicators 312 through user interface 320, text recognition 310 analyzes indicators 312, status 314, and/or location 316 to determine whether activities described in entries in set of entries 306 are low usage activities and identify low usage time intervals associated with the low usage activities.

In this example, text recognition 310 parses text in set of entries 306 to obtain information describing activities scheduled in calendar 304. Text recognition 310 uses this information to identify activities that require low usage of computer resources or no usage of computer resources. Text recognition 310 automatically sets an indicator in indicators 312 to designate time intervals as low usage time intervals in response to identifying time intervals associated with these low usage activities.

Text recognition 310 also uses status 314 as well as location 316 indicators 312 to determine whether an entry from among the set of entries 306 is a low usage time interval to execute a process. In other words, text recognition 310 uses information generated by performing an analysis on entries in calendar 304, as well as information in calendar 304 that was manually entered by a user.

In this example, text recognition 310 looks at multiple factors to determine whether a given time interval is a low usage time interval. The factors include, without limitation, whether status 314 indicates the user associated with calendar 304 is on vacation, whether the user is the chairman of a scheduled meeting, whether the user will be using the computer during a meeting, or whether a certain day is a preferred day for backup.

When text recognition 310 identifies a set of one or more low usage time intervals, text recognition 310 transmits the set of low usage time intervals to backup controller 308. Backup controller 308 schedules execution of a maintenance process, such as backup process 302, during one or more low usage time intervals in the set of identified low usage time intervals.

However, since such an interpretation from text recognition 310 may be error-prone, backup process may require that this be indicated only manually by the user setting a flag or indicator indicating a low usage time interval.

Referring now to FIG. 4, a block diagram of a calendar entry screen having a low usage indicator is depicted in accordance with an illustrative embodiment. Screen shot 400 is a screen shot of the calendar entry screen. Screen shot 400 is an example of a calendar entry screen that notifies a user about an event, and simultaneously allows a user to choose the time of the event for performing a backup. Field 404 is a field in the calendar entry that contains information describing an event. At field 404, the event given as an example is a tech meeting. The tech meeting takes place on a date and time that is set by the user.

Execute backup flag 406 is a flag that can be manually set by a user to indicate that the time interval associated with the event described in field 404 is a low usage time interval during which a maintenance process, such as a backup process, can be executed. However, the backup controller still determines whether the backup process will be executed during this low usage time interval or during a different low usage time interval.

In another embodiment, if the user sets execute backup flag 406, the backup process will be executed during this time interval regardless of any other low usage time intervals that may be available.

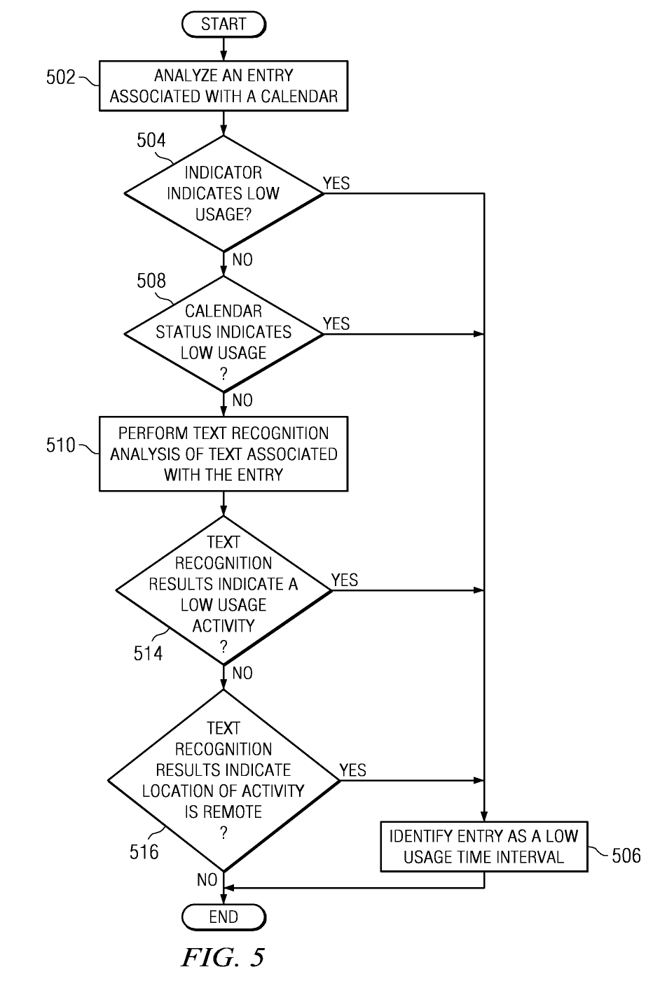

FIG. 5 is a flowchart illustrating a process for identifying low usage time intervals using information from a calendar in accordance with an illustrative embodiment. The process in FIG. 5 analyzes an entry associated with a calendar to determine low usage time intervals. This process is implemented by a software component for parsing calendar entries to identify low usage time intervals, such as text recognition 310 in FIG. 3.

The process begins by analyzing an entry associated with a calendar (step 502). Next, the process makes a determination as to whether an indicator indicates low usage of computer resources during a given time interval (step 504). If the indicator indicates low usage, the process identifies the entry as a low usage time interval (step 506). The process terminates thereafter.

Returning to step 504, if an indicator indicating low usage is not present, the process makes a determination as to whether the calendar status indicates low usage (step 508). If the calendar status indicates low usage, then the process identifies the entry as a low usage time interval (step 506) and terminates thereafter.

Returning to step 508, if a status indicating low usage is not present, the process performs text recognition analysis of text associated with the entry (step 510). Next, the process makes a determination as to whether the text recognition results indicate a low usage activity (step 514). If the text recognition results indicate a low usage activity, then the process identifies the entry as a low usage time interval (step 506) and terminates thereafter.

Returning to step 514, if the text recognition results do not indicate a low usage activity, then the process makes a determination as to whether the text recognition results indicate the location of the activity is remote to the computer (step 516). If the text recognition results indicate the location of the activity is remote, then the process identifies the entry as a low usage time interval (step 506) and terminates thereafter. If the text recognition results indicate a location of the activity is not remote, then the process terminates thereafter.

The steps shown in FIG. 5 may be performed in a different order and/or steps may be executed concurrently. For example, in other embodiments, the process may begin with a determination whether the status indicates low usage which is located at step 508 or with a determination as to whether the location indicates low usage at step 516.

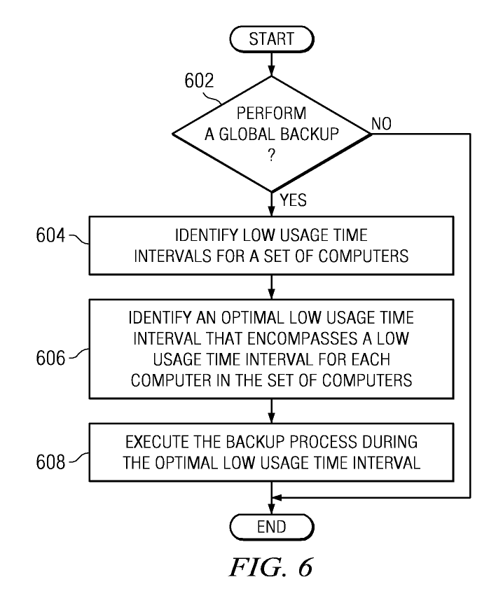

Turning now to FIG. 6, a flowchart illustrating a process for using information from a calendar to perform a global backup is shown in accordance with an illustrative embodiment. The process in FIG. 6 is implemented by a software process for managing, controlling, scheduling, and/or initiating execution of a maintenance process, such as backup controller 308 in FIG. 3.

The process begins by making a determination whether to perform a global backup (step 602). If the process determines not to perform a global backup, then the process terminates thereafter. If the process makes a determination that a global backup is to be performed, then the process identifies low usage time intervals for a set of computers (step 604). Next, the process identifies an optimal low usage time interval that encompasses a low usage time interval for each computer in the set of computers (step 606). The process executes the global backup during the optimal low usage time interval (step 608) with the process terminating thereafter.

The illustrative embodiments have been described as being implemented to schedule execution of a backup process during a low usage time interval. However, the illustrative embodiments are not limited to utilization with backup processes. The embodiments may also be used to schedule execution of any type of maintenance process, including, without limitation, a virus scan, a disk defragmentation, a compression, a checkpoint process, a restart process, a migration process, a software update, a diagnostic process, a trap handler, a manipulation of a text index, or any other type of maintenance process.

The illustrative embodiments provide a computer implemented method, apparatus, and computer usable program code for automatically scheduling a time to backup data using information from a calendar. In one embodiment, the process analyzes entries in a set of electronic calendars. The electronic calendars are associated with a set of users. The electronic calendars are used to generate expected computer usage patterns for the set of users. The process then identifies a low usage time interval for a computer using the expected computer usage patterns. A low usage time interval for the computer is a time interval when expected usage of the computer by the set of users does not exceed a threshold amount of usage. The process is automatically executed during the low usage time interval.

This process allows for a more efficient and less disruptive backup process. In addition, the process minimizes the amount of work required by a user to ensure that backup processes occur at a time that will be least disruptive to the user and the work being performed by the user on a computing device on which a backup process is being performed.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the steps may occur out of the order noted in the figures. For example, two steps shown in succession may, in fact, be executed substantially concurrently, or the steps may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk, millipede storage technology, Magneto-resistive random access memory (MRAM), or phase-change memory, also known as PCM, PRAM, Ovonic Unified Memory, and Chalcogenide RAM (C-RAM). Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented as a method for performing a backup process. However, the method may also be applied to other processes. As an example only and without any limitation, other processes that a user may schedule using information from a calendar include a virus scan, a file compression process, a disk backup process, a checkpoint process, a restart process, and a disk de-fragmentation process.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for automatically scheduling execution of a process using information in a calendar, the computer implemented method comprising:
analyzing entries in a set of electronic calendars associated with a set of users to generate expected computer usage patterns for the set of users;
identifying a low usage time interval for a computer using the expected computer usage patterns, wherein the low usage time interval for the computer is a time interval when expected usage of the computer by the set of users does not exceed a threshold amount of usage; and
automatically executing the process during the low usage time interval.

2. The computer implemented method of claim 1 wherein the process is a backup process.

3. The computer implemented method of claim 1 wherein the process is at least one of a virus scan, a file compression process, a disk backup process, a checkpoint process, a restart process, a text index manipulation process, and a disk de-fragmentation process.

4. The computer implemented method of claim 1 further comprising:
receiving the entries in the set of electronic calendars from a client, by a server, wherein the server analyzes the entries in the set of electronic calendars to generate the expected computer usage patterns and identify the low usage time interval for the computer using the expected computer usage patterns; and
transmitting the low usage time interval for the computer to the client.

5. The computer implemented method of claim 1 further comprising:
identifying a low usage time interval for each computer in a set of computers using the expected computer usage patterns to form low usage time intervals;
identifying an optimal low usage time interval, wherein the optimal low usage time interval comprises a low usage time interval for each computer in the set of computers; and
automatically executing the process in each computer in the set of computers during the optimal low usage time interval.

6. The computer implemented method of claim 1 wherein analyzing the entries in the set of electronic calendars further comprises:
identifying an entry in the set of entries associated with a given user in the set of users; and
responsive to identifying a low usage indicator flag associated with the entry, identifying a time interval associated with the entry as a low usage time interval.

7. The computer implemented method of claim 1 wherein analyzing the entries in the set of electronic calendars further comprises:
identifying an entry in the set of entries associated with a given user in the set of users; and
responsive to a calendar status associated with the calendar entry indicating a user is on vacation, identifying a time interval associated with the calendar status as a low usage time interval.

8. The computer implemented method of claim 1 wherein analyzing the entries in the set of electronic calendars further comprises:
identifying an entry in the set of entries associated with a given user in the set of users; and
performing a text analysis on text associated with the entry to form text analysis results;
responsive to the text analysis results indicating that an expected location of the given user is a different location than a location of the computer, identifying a time interval associated with the entry as a low usage time interval; and
responsive to the text analysis results indicating that an activity described in the entry is a low usage activity, identifying the time interval associated with the entry as the low usage time interval.

9. The computer implemented method of claim 1 wherein a calendar in the set of electronic calendars associated with a set of users is a calendar in an email program.

10. The computer implemented method of claim 1 wherein a calendar in the set of electronic calendars associated with a set of users is a calendar in a personal digital assistant.

11. A computer program product comprising:
a computer usable medium including computer usable program code for automatically scheduling execution of a process using information in a calendar, said computer program product comprising:
computer usable program code for analyzing entries in a set of electronic calendars associated with a set of users to generate expected computer usage patterns for the set of users;
computer usable program code for identifying a low usage time interval for a computer using the expected computer usage patterns, wherein the low usage time interval for the computer is a time interval when expected usage of the computer by the set of users does not exceed a threshold amount of usage; and
computer usable program code for automatically executing the process during the low usage time interval.

12. The computer program product of claim 11 wherein the process is a backup process.

13. The computer program product of claim 11 wherein the process is at least one of a virus scan, a file compression process, a disk backup process, a checkpoint process, a restart process, a text index manipulation process, and a disk de-fragmentation process.

14. The computer program product of claim 11 further comprising:
computer usable program code for receiving the entries in the set of electronic calendars from a client, by a server, wherein the server analyzes the entries in the set of electronic calendars to generate the expected computer usage patterns and identify the low usage time interval for the computer using the expected computer usage patterns; and
computer usable program code for transmitting the low usage time interval for the computer to the client.

15. The computer program product of claim 11 further comprising:
computer usable program code for identifying a low usage time interval for each computer in a set of computers using the expected computer usage patterns to form low usage time intervals;
computer usable program code for identifying an optimal low usage time interval, wherein the optimal low usage time interval comprises a low usage time interval for each computer in the set of computers; and
computer usable program code for automatically executing the process in each computer in the set of computers during the lowest usage time interval.

16. The computer program product of claim 11 wherein analyzing the entries in the set of electronic calendars further comprises:
computer usable program code for identifying an entry in the set of entries associated with a given user in the set of users; and
computer usable program code for identifying a time interval associated with the entry as a low usage time interval in response to identifying a low usage indicator flag associated with the entry.

17. The computer program product of claim 11 wherein analyzing the entries in the set of electronic calendars further comprises:
computer usable program code for identifying an entry in the set of entries associated with a given user in the set of users; and
computer usable program code for identifying a time interval associated with the calendar status as a low usage time interval in response to a calendar status associated with the calendar entry indicating a user is on vacation.

18. The computer program product of claim 11 wherein analyzing the entries in the set of electronic calendars further comprises:
computer usable program code for identifying an entry in the set of entries associated with a given user in the set of users; and
computer usable program code for performing a text analysis on text associated with the entry to form text analysis results;
computer usable program code for identifying a time interval associated with the entry as a low usage time interval in response to the text analysis results indicating that an expected location of the given user is a different location than a location of the computer; and
computer usable program code for identifying the time interval associated with the entry as the low usage time interval in response to the text analysis results indicating that an activity described in the entry is a low usage activity.

19. A computer implemented method for automatically scheduling execution of a maintenance process using information in a calendar, the computer implemented method comprising:
identifying an entry in an electronic calendar associated with a user of a computing device;
responsive to identifying a low usage indicator flag associated with the entry, identifying a time interval associated with the entry as a low usage time interval in a set of low usage time intervals, wherein the low usage time interval is a time interval when expected usage of the computer by the user does not exceed a threshold amount of usage;
responsive to an absence of the low usage indicator flag associated with the entry, performing a text analysis on text associated with the entry to form text analysis results;
responsive to the text analysis results indicating that an expected location of the given user is a different location than a location of the computer, identifying a time interval associated with the entry as a low usage time interval in the set of low usage time intervals; and
responsive to the text analysis results indicating that an activity described in the entry is a low usage activity, identifying the time interval associated with the entry as the low usage time interval in the set of low usage time intervals; and
automatically executing the maintenance process during the low usage time interval.

20. The computer implemented method of claim 19 further comprising:
analyzing a plurality of entries in a set of electronic calendars associated with a set of users to generate expected computer usage patterns for the set of users;
identifying a plurality of low usage time intervals for the computer using the expected computer usage patterns, wherein the low usage time interval for the computer is a time interval when expected usage of the computer by the set of users does not exceed a threshold amount of usage; and
automatically executing the maintenance process in each computer in the set of computers during a low usage time interval in the set of lowest usage time intervals, wherein the backup process is executed in each computer in the set of computers during the low usage time interval for the each computer.
